(19) United States
(12) Patent Application Publication
(10) Pub. No.: US 2016/0238749 A1
(43) Pub. Date: Aug. 18, 2016

(54) LIGHT CONTROL FILM

(71) Applicant: BenQ Materials Corporation, Taoyuan City (TW)

(72) Inventors: Meng-Chieh CHOU, Taoyuan City (TW); Yao-Yu CHEN, Taoyuan City (TW)

(21) Appl. No.: 14/968,869

(22) Filed: Dec. 14, 2015

(30) Foreign Application Priority Data
Feb. 13, 2015 (TW) 104202487

(51) Int. Cl. G02B 5/02; G02B 19/00; F21S 11/00

(52) U.S. Cl. CPC G02B 5/0231; F21S 11/002; G02B 19/0042; G02B 5/0278; G02B 19/0009

(57) ABSTRACT

The invention is related to a light control film. The light control film includes a transparent substrate having a light incident surface and a light emitting surface, and a plurality of microcavity structures formed on the light incident surface of the transparent substrate. The microcavity structures are in inverted-pyramid shape and each microcavity structure is formed by at least four faces.

### RELATED APPLICATIONS

This application claims the priority benefit of Taiwanese application serial no. 104202487, filed on Feb. 13, 2015, the full disclosure of which is incorporated herein by reference.

### BACKGROUND

1. Field of Invention

The present invention relates to a light control film, which is used for efficiently adjusting the distribution of sunlight in indoor space. Especially, the light control film is applied on windows or curtains to provide energy saving performance.

2. Description of Related Art

Recently, with the raise of consciousness of energy saving, energy saving of building lighting has become a popular topic of research. In addition to utilizing artificial lighting source for energy conservation, energy saving strategy of utilizing natural light has been promoted extensively.

In general, for increasing the utilization rate of sunlight, the optical film with micro lens structures thereon is usually used for concentrating sunlight inside of buildings so as to enhance the illumination inside of the buildings. However, in this way, the micro lens structures on the optical film would lead to obvious rainbow pattern defect on the window so as to result in human eyes to feel uncomfortable. At the same time, the original light transmittance of the window is also reduced. Moreover, when the sunlight is introduced into the indoor space by the way of micro lens structures, it is just concentrated on the ceiling, thereby partly enhancing indoor illumination. Therefore, the sunlight could not distribute uniformly inside of the buildings.

### SUMMARY

According to aforementioned reasons, the present invention is to provide a novel light control film, which could solve the problems mentioned above.

According to an aspect of the present invention, the light control film includes a transparent substrate having a light incident surface and a light emitting surface; and a plurality of microcavity structures formed on the light incident surface of the transparent substrate wherein the microcavity structures are in inverted-pyramid shape and each microcavity structure is formed by at least four faces.

The microcavity structures on the light control film of the present invention are designed for improving the rainbow pattern defect on the window and make sunlight distribute uniformly in the indoor space at the same time. Moreover, a patterned adhesive coating layer on the microcavity structures of the present invention is also provided in the present invention. The patterned adhesive coating layer on the microcavity structures is designed to prevent the microcavity structures from damage, to enhance illumination in the indoor space and to provide thermal insulation performance.

In an embodiment of the present invention, the faces of each microcavity structure form an opening plane and an included angle between each face and the opening plane is in the range of 45 degree to 85 degree.

In an embodiment of the present invention, a side length of the opening plane is in the range of 25 μm to 750 μm.

In an embodiment of the present invention, a depth of the microcavity structure is in the range of 45 μm to 2250 μm.

In an embodiment of the present invention, the microcavity structures are same or different.

In an embodiment of the present invention, the microcavity structures are arranged continuously or discontinuously.

In an embodiment of the present invention, the microcavity structures are arranged in a linear array, a curved array, a grid array, a random arrangement or a combination thereof.

In an embodiment of the present invention, a material of the transparent substrate is selected from the group consisting of polyester, polyethylene terephthalate (PET), polycarbonate (PC), acrylate resin, polymethyl methacrylate (PMMA) and poly urethane (PU).

In an embodiment of the present invention, the microcavity structures are made of a thermal curable material or a UV curable material.

In an embodiment of the present invention, the light control film further includes a patterned functional layer disposed on at least one microcavity structure.

The forgoing presents a simplified summary of the disclosure in order to provide a basic understanding of the present invention. This summary is not an extensive overview of the disclosure and it does not identify key/critical elements of the present invention or delineate the scope of the present invention. Its sole purpose is to present concepts disclosed herein in a simplified form as a prelude to the more detailed description that is presented later.

Many of the attendant features will be more readily appreciated as the same becomes better understood by reference to the following detailed description considered in connection with the accompanying drawings. It is noteworthy that the drawings shown in the figures are for illustrative purposes only and not to scale.

### BRIEF DESCRIPTION OF THE DRAWINGS

FIG. 1A shows a schematic diagram of a top view of a light control film 100 of a preferred embodiment of the present invention.

FIG. 1B shows a schematic diagram of a side view of a light control film 100 of a preferred embodiment of the present invention.

FIG. 2A shows a schematic diagram of the light path when the light go through the light control film 200 of the present invention.

FIG. 2B shows a schematic diagram of an enlarged view of the microcavity structure 220 of the present invention.

FIG. 3 shows a schematic diagram of a top view of a light control film 300 of another preferred embodiment of the present invention.

FIG. 4 shows a schematic diagram of a cross-sectional view of the light adjusting film 400 of another preferred embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details.

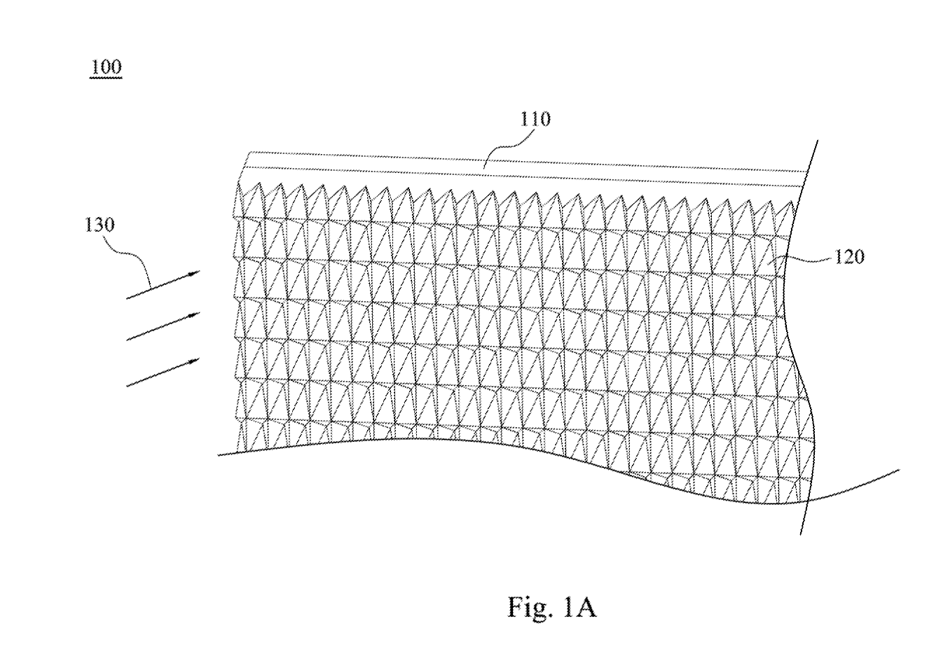

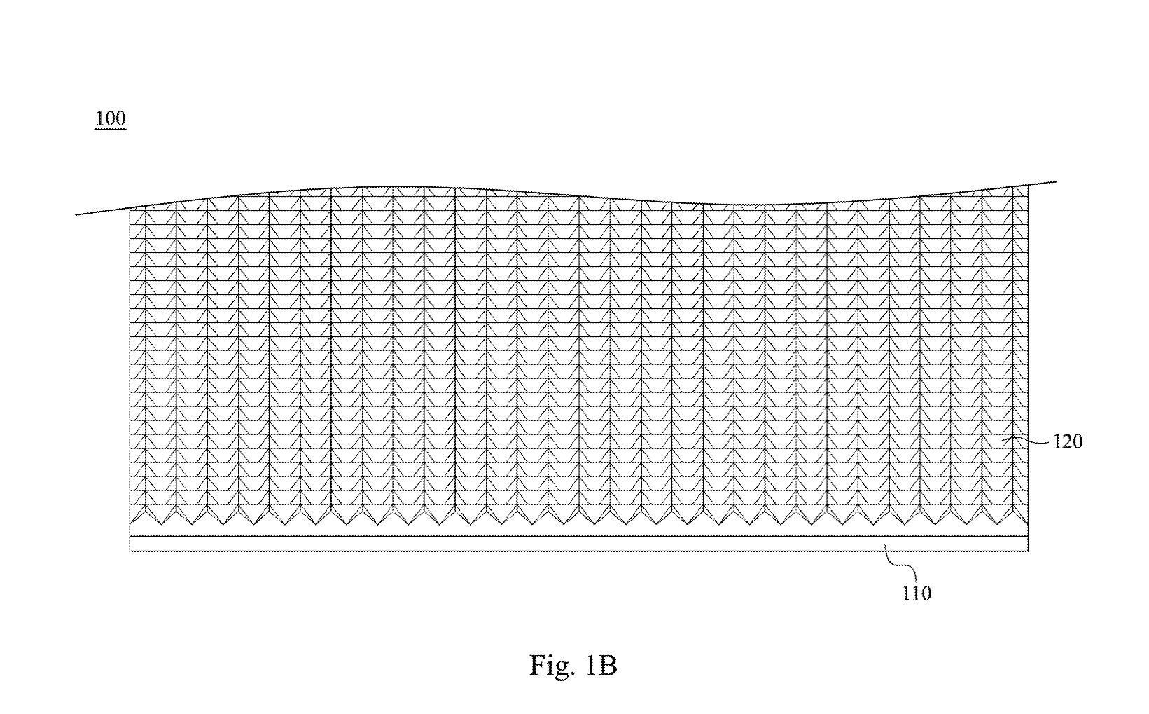

FIG. 1A is a schematic diagram of a top view of a light control film 100 according to a preferred embodiment of the present invention. FIG. 1B is a schematic diagram of a side view of a light control film 100 of a preferred embodiment of the present invention is shown.

In the FIG. 1A, in addition to the light control film 100, a light source 130 is also illustrated therein. The light control film 100 includes a transparent substrate 110 and a plurality of microcavity structures 120 formed on a light incident surface of the transparent substrate. The light source may be, but not limited to, sunlight.

Referring to FIG. 1B, the microcavity structures 120 of the light control film 100 are in inverted-pyramid shape and each microcavity structure are arranged continuously and in a grid array on the transparent substrate 110.

The aforementioned microcavity structures on the light control film are in inverted-pyramid shape and each microcavity structure is formed by at least four faces. For example, the shape of the microcavity structure may be, but not limited to, a quadrangular pyramid shape, a hexagonal pyramid shape or multi-pyramid shape. In another embodiment of the present invention, the microcavity structures on the light control film are formed by six faces.

Moreover, microcavity structures on the light control film are same or different and theses microcavity structures thereon are arranged continuously or discontinuously. In another embodiment of the present invention, each microcavity structure on the light control film is different from each other.

The microcavity structures on the light control film are arranged in a linear array, a curved array, a grid array, a random arrangement or a combination thereof. In another embodiment of the present invention, the microcavity structures on the light control film are in a random arrangement.

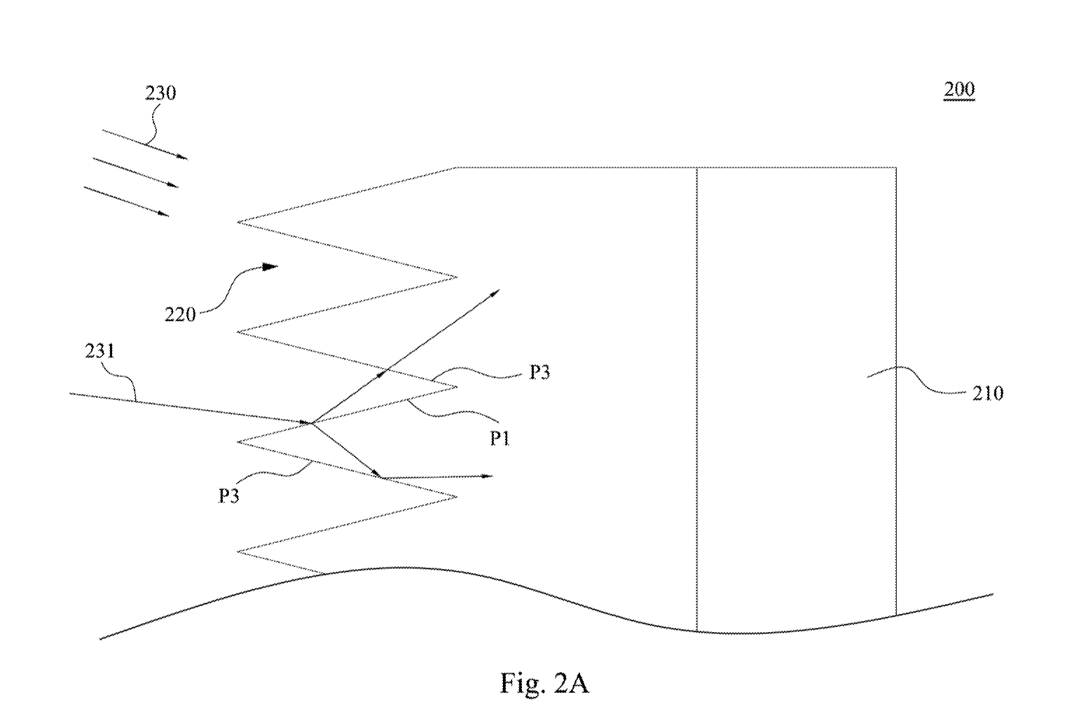

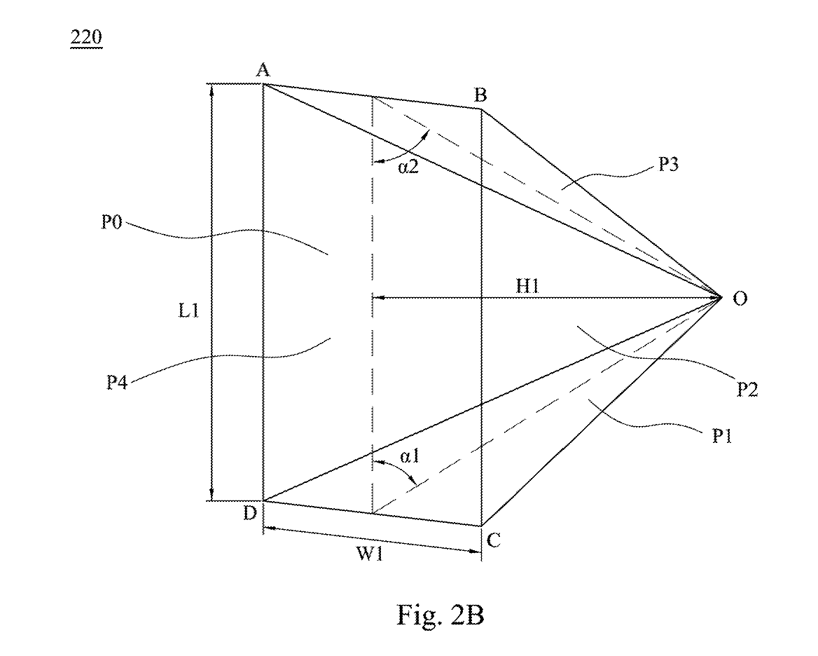

FIG. 2A is a schematic diagram of the light path when the light go through the light control film 200 of the present invention. FIG. 2B is a schematic diagram of an enlarged view of the microcavity structure 220 of the present invention. The detail explanations are described as below and please refer to FIG. 2A and FIG. 2B at the same time.

In the FIG. 2A, the light control film 200 includes a transparent substrate 210 and a plurality of microcavity structures 220 formed on the light incident surface of the transparent substrate. In the FIG. 2B, each microcavity structure is formed by four faces like P1, P2 P3 and P4. The face P1 is formed by joining three vertices O, C, and D. The face P2 is formed by joining three vertices O, B, and C. The face P3 is formed by joining three vertices O, A, and B. The face P4 is formed by joining three vertices O, A, and D. Then, the four faces P1, P2, P3 and P4 of the microcavity structure are formed an opening plane P0.

When the light source 230 in FIG. 2A emits the incident light 231 to the light control film 200, some part of the incident light 231 will be reflected on the face P1 of the microcavity structure, then goes through the face P3 thereof and in final, the incident light 231 would be introduced to the ceiling in the indoor space.

At the same time, the other part of incident light 231 will go through the face P1 of the microcavity structure, then it conducted a total reflection on the face P3 thereof, and in final, the incident light 231 is transformed to the parallel light into the indoor space.

Thus, for making incident light which is distributed uniformly into the indoor space, the included angle α1 between each face, such as face P1 of the microcavity structure 220 on the light control film 200 and the opening plane P0 is in the range of 45 degree to 85 degree, preferably in the range of 45 degree to 65 degree, and more preferably in the range of 55 degree to 65 degree. The included angle α2 between face P3 opposite to the face P1 of the microcavity structure 220 on the light control film 200 and the opening plane P0 is in the range of 45 degree to 85 degree, preferably in the range of 70 degree to 85 degree, and more preferably in the range of 80 degree to 85 degree.

Besides, in the embodiment of the present invention, the side length L1 of the opening plane P0 is in the range of 25 μm to 750 μm, preferably in the range of 25 μm to 500 μm, and more preferably in the range of 25 μm to 250 μm. The depth H1 of the microcavity structure is in the range of 45 μm to 2250 μm, preferably in the range of 45 μm to 1500 μm, and more preferably in the range of 45 μm to 600 μm.

The side length of the opening plane, the depth of the microcavity structure and the included angle between the opening plane and the face of the microcavity structure on the light control film are designed to adjust the optical path of light. Therefore, users could adjust the characters of the microcavity structure arbitrarily according to their different requirements.

A material of the transparent substrate of the light control film of the present invention is selected from the group consisting of polyester, polyethylene terephthalate (PET), polycarbonate (PC), acrylate resin, polymethyl methacrylate (PMMA) and poly urethane (PU). The microcavity structures on the light control film are made of a thermal curable material or a UV curable material.

In the embodiment of the present invention, the transparent substrate 210 of the light control film 200 is made of polyethylene terephthalate (PET) and the microcavity structures 220 are made of a UV curable material.

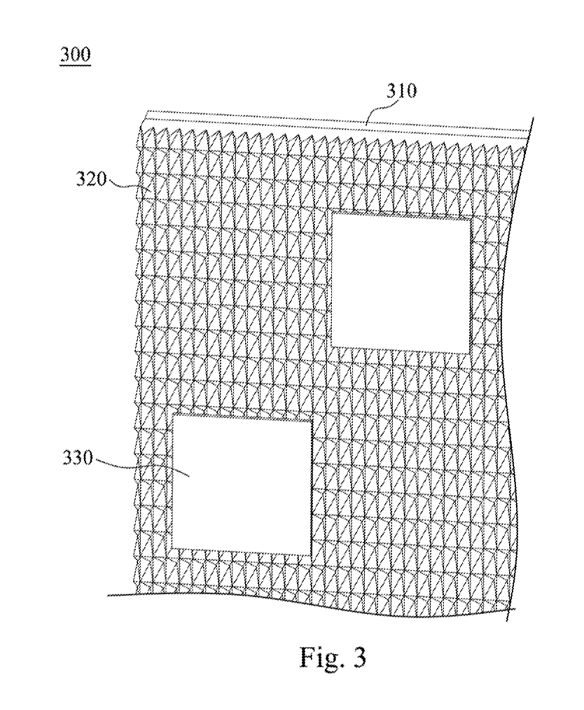

FIG. 3 is a schematic diagram of a top view of a light control film 300 of another preferred embodiment of the present invention. The light control film 300 includes a transparent substrate 310, a plurality of microcavity structures 320 formed on the light incident surface of the transparent substrate 310 and a functional patterned coating layer 330 disposed on at least one microcavity structure.

The functional patterned coating layer 330 is used to enhance illumination in the indoor space and to provide thermal insulation performance.

The patterned coating layer 330 is a functional layer selected from the group consisting of an adhesive layer, a hard coating layer, a low energy surface coating layer, an IR absorbing layer and an UV absorbing layer. In the embodiment of the present invention, the patterned coating layer 330 is an adhesive layer so as to make the light control film 300 able to be adhered on the window. On one hand, the patterned functional coating layer 330 is capable of preventing the microcavity structures 320 on the light control film 300 from damage. On the other hand, the patterned functional coating layer 330 is used to provide thermal insulation performance.

In addition, a functional patterned coating layer may also disposed on the light emitting surface of the transparent substrate 310 of the light control film 300. For example, the functional patterned coating layer may be, but not limited to, an adhesive layer, a hard coating layer, a low energy surface coating layer, an IR absorbing layer, an UV absorbing layer and a combination thereof.

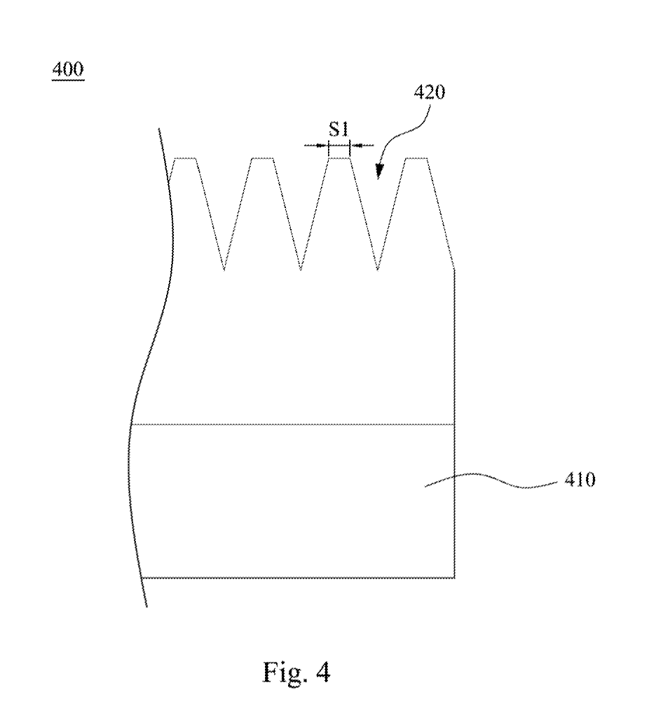

Referring to FIG. 4, a schematic diagram of a cross-sectional view of the light adjusting film 400 of another preferred embodiment of the present invention is shown. The light control film 400 includes a transparent substrate 410 and a plurality of microcavities structures 420 formed on the light incident surface of the transparent substrate 410. The difference between the light control film 400 and the light control film 100 is the different arrangement of the microcavities structures. Each of microcavity structures 420 on the light control film 420 is arranged discontinuously. The pitch S1 between each microcavity structure 420 is in the range of 0.01 μm to 20 μm, preferably in the range of 0.01 μm to 10 μm, and more preferably in the range of 0.01 μm to 4 μm.

The light control film of the present invention is manufactured by various methods, which would be known to the person skilled in the art, such as embossing, extrusion, molding and injection molding. For example, one method of embossing includes but not limited to coating a curable resin on one side of the transparent substrate, then embossing the curable resin with a predetermined pattern to form a plurality of microcavities structures on the transparent substrate, curing the microcavities structures on the transparent substrate, and the light control film is obtained in final.

The light control film of the present invention can be arranged partially or completely on the transparent substrate. The term “partially” as used herein refers to that the light control film is arranged in “an interval arranged pattern”, “a chessboard-like pattern” or other patterns, but not limited to these patterns. According to different requirements, users can choose different patterns to meet their need.

While the invention has been described by way of example(s) and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light control film, comprising:
a transparent substrate having a light incident surface and a light emitting surface; and
a plurality of microcavity structures formed on the light incident surface of the transparent substrate;
wherein the microcavity structures are in inverted-pyramid shape and each microcavity structure is formed by at least four faces.

2. The light control film according to claim 1, wherein the faces form an opening plane and an included angle between the face and the opening plane is in the range of 45 degree to 85 degree.

3. The light control film according to claim 1, wherein a side length of the opening plane is in the range of 25 μm to 750 μm.

4. The light control film according to claim 1, wherein a depth of the microcavity structure is in the range of 45 μm to 2250 μm.

5. The light control film according to claim 1, wherein the microcavity structures are same or different.

6. The light control film according to claim 1, wherein the microcavity structures are arranged continuously or discontinuously.

7. The light control film according to claim 1, wherein the microcavity structures are arranged in a linear array, a curved array, a grid array, a random arrangement or a combination thereof.

8. The light control film according to claim 1, wherein a material of the transparent substrate is selected from the group consisting of polyester, polyethylene terephthalate (PET), polycarbonate (PC), acrylate resin, polymethyl methacrylate (PMMA) and poly urethane (PU).

9. The light control film according to claim 1, wherein the microcavity structures are made of a thermal curable material or a UV curable material.

10. The light control film according to claim 1, further comprising a patterned functional coating layer disposed on at least one microcavity structure.
